(19) United States
(12) Patent Application Publication
(10) Pub. No.: US 2025/0079821 A1
(43) Pub. Date: Mar. 6, 2025

(54) METHOD FOR UPDATING ELECTRONIC CIRCUIT BREAKER FIRMWARE TO AVOID LOAD DE-ENERGIZATION

(71) Applicant: Siemens Industry, Inc., Alpharetta, GA (US)

(72) Inventors: Amit Nayak, Atlanta, GA (US); Westin Williams, Marietta, GA (US)

(73) Assignee: Siemens Industry, Inc., Alpharetta, GA (US)

(21) Appl. No.: 18/457,942

(22) Filed: Aug. 29, 2023

(51) Int. Cl. H02H 1/00; G06F 9/4401; H01H 71/12; H01H 83/20

(52) U.S. Cl. CPC H02H 1/0092; G06F 9/441; H01H 71/123; H01H 83/20; H01H 2083/205

(57) ABSTRACT

Systems and methods are provided for maintaining the functionality of an electronic circuit breaker during a firmware update. The electronic circuit breaker includes at least two microcontrollers. When a first microcontroller of the at least two microcontrollers is updated, a second microcontroller of the at least two microcontrollers remain active and continues to run a safety algorithm allowing the electronic circuit breaker to continuously monitors its load without any disruptions.

### FIELD

This disclosure relates to maintaining safety protocols while updating an electronic circuit breaker.

### BACKGROUND

Electronic circuit breakers provide safety against various faults and abnormal conditions to electrical wiring and loads for respective branches that the electronic circuit breakers are monitoring within power distribution panels. These faults and abnormal conditions may cause fire or destruction of property or loads connected to the branches. Damage or injury to humans may occur if monitoring is discontinued for even a brief period of time.

Newer electronic circuit breakers provide new and additional features such as advanced monitoring of loads, setting alarms, and protecting against over and under voltage level, over and under temperature levels, and over and under power levels, among other features. These new electronic circuit breakers may also be configured to be updated over a wireless network. For example, to correct issues and provide additional or improved features, the firmware within the electronic circuit breakers may be securely and remotely updated without having to physically interact with the electronic circuit breaker. At the end of the update process, a microcontroller or microprocessor that is updated in this fashion is to be reset or rebooted for the new firmware to run. A reset/reboot event may cause the load to be briefly de-energized and/or a safety algorithm to be disengaged. The branch monitored by the circuit breaker will end up briefly offline or not safely monitored.

When the electronic circuit breaker is not active (e.g., when an update is in process), there is a possibility of an inconvenience and danger to equipment and residents. A household load the residents of the household want to run may be deactivated or otherwise not safe to use. During these brief unmonitored periods of time, the electrical branch monitored by the respective electronic circuit breaker is vulnerable, which may result in an inconvenience and potential safety hazard.

### SUMMARY

By way of introduction, the preferred embodiments described below include methods and systems for maintaining the functionality of an electronic circuit breaker during a firmware update.

In an embodiment, a method for updating an electronic circuit breaker with new firmware is provided. The method includes: receiving, by a radio, a firmware update for the electronic circuit breaker; disengaging, by a multiplexor, inputs to and outputs from a first microcontroller while maintaining inputs to and outputs from a second microcontroller, wherein the first microcontroller and second microcontroller are both configured to monitor the electronic circuit breaker and run a safety algorithm based on the respective inputs to and outputs from the multiplexor; updating the first microcontroller with the firmware update, wherein the second microcontroller is configured to continue to monitor the electronic circuit breaker and run the safety algorithm while the first microcontroller is updated; and restarting the first microcontroller, wherein after the restarting, the first microcontroller is configured to monitor the electronic circuit breaker and run the safety algorithm using the new firmware update.

The method may further include disengaging, by the multiplexor, inputs to and the outputs from the second microcontroller while maintaining inputs to and the outputs to the first microcontroller; updating the second microcontroller with the firmware update, wherein the first microcontroller is configured to continue to monitor the electronic circuit breaker and run the safety algorithm while the second microcontroller is updated; and restarting the second microcontroller, wherein after the restart, the second microcontroller is configured to monitor the electronic circuit breaker and run the safety algorithm using the new firmware update.

In an embodiment, the radio receives individual packets from a remote device comprising the firmware update, wherein the radio further receives a stop packet or an end packet to signify a completion of a receipt of the firmware update. Further, after receiving the firmware update, the radio may instruct the multiplexor to disengage inputs to and the outputs from the first microcontroller. The radio may be configured to receive the firmware update wirelessly.

In an embodiment, the firmware update is stored in each of the first microcontroller and the second microcontroller after receipt by the radio and prior to updating the first microcontroller. Alternatively, the firmware update is stored in a nonvolatile flash memory external to the first microcontroller and the second microcontroller.

In an embodiment, the method further includes receiving an acknowledgement from the host selection interrupt line prior to the multiplexor disengaging inputs to and outputs from the first microcontroller.

In an embodiment, an alternative method for updating an electronic circuit breaker with new firmware is provided. The method includes: receiving, by a radio, a firmware update for the electronic circuit breaker; instructing, by an updatable microcontroller, a backup microcontroller to begin safety monitoring during an update procedure for the updatable microcontroller; updating the updatable microcontroller with the firmware update, wherein the backup microcontroller is configured to continue to monitor the electronic circuit breaker and run a safety algorithm while the updatable microcontroller is updating; and restarting the updatable microcontroller, wherein after the restart the updatable microcontroller is configured to monitor the electronic circuit breaker and run the safety algorithm using the firmware update.

The backup microcontroller may function as a pass though circuit for signals from the electronic circuit breaker while the updatable microcontroller is active, wherein when the updatable microcontroller is deactivated, the backup microcontroller performs the safety algorithm. Additionally, the backup microcontroller may never be updated.

In an embodiment, the method further includes receiving an acknowledgement from a trip detection or power cycle detection module prior to the updatable microcontroller instructing the backup microcontroller to begin the safety monitoring. The radio may be configured to receive the firmware update wirelessly.

In an embodiment, an electronic circuit breaker is provided. The electronic circuit breaker includes two or more microcontrollers and a radio. The two or more microcontrollers are configured to run an algorithm for monitoring and controlling a load of the electronic circuit breaker. The radio is configured to receive new firmware data from a remote device, the new firmware data configured to alter the algorithm. The first microcontroller of the two or more microcontrollers actively runs the algorithm when a second microcontroller of the two or more microcontrollers is deactivated and updated with the new firmware data.

The electronic circuit breaker may include a multiplexor configured to provide inputs to and receive outputs from the two or more microcontrollers. After receiving the new firmware data, the radio instructs the multiplexor to disengage inputs to and outputs from the first microcontroller.

In an embodiment, subsequent to the second microcontroller being restarted or rebooted after being updated, the second microcontroller is configured to run the algorithm while the first microcontroller is deactivated and updated with the new firmware data.

In an embodiment, the first microcontroller is not updatable. The first microcontroller functions as a backup for when the second microcontroller is deactivated. The first microcontroller functions as a pass though circuit for signals from the electronic circuit breaker while the second microcontroller is active, wherein when the second microcontroller is deactivated, the first microcontroller performs the algorithm.

In an embodiment, the electronic circuit breaker further includes a nonvolatile flash memory external to the two or more microcontrollers, the nonvolatile flash memory configured to store the received new firmware data.

Any one or more of the aspects described above may be used alone or in combination. These and other aspects, features and advantages will become apparent from the following detailed description of preferred embodiments, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

FIG. 1 depicts an example electronic circuit breaker.

FIG. 2 depicts a system for maintaining the functionality of an electronic circuit breaker during a firmware update according to an embodiment.

FIG. 3 depicts a method for maintaining the functionality of an electronic circuit breaker during a firmware update using the system of FIG. 2 according to an embodiment.

FIG. 4 depicts an updatable electronic circuit breaker according to an embodiment.

FIG. 5 depicts an alternative system for maintaining the functionality of an electronic circuit breaker during a firmware update according to an embodiment.

FIG. 6 depicts an alternative method for maintaining the functionality of an electronic circuit breaker during a firmware update using the system of FIG. 4 according to an embodiment.

FIG. 7 depicts another alternative system for maintaining the functionality of an electronic circuit breaker during a firmware update according to an embodiment.

FIG. 8 depicts another alternative method for maintaining the functionality of an electronic circuit breaker during a firmware update using the system of FIG. 4 according to an embodiment.

FIG. 9 depicts an example system for maintaining the functionality of an electronic circuit breaker during a firmware update according to an embodiment.

FIG. 10 depicts an example method for maintaining the functionality of an electronic circuit breaker during a firmware update using the system of FIG. 11 according to an embodiment.

FIG. 11 depicts an updatable electronic circuit breaker according to an embodiment.

### DETAILED DESCRIPTION

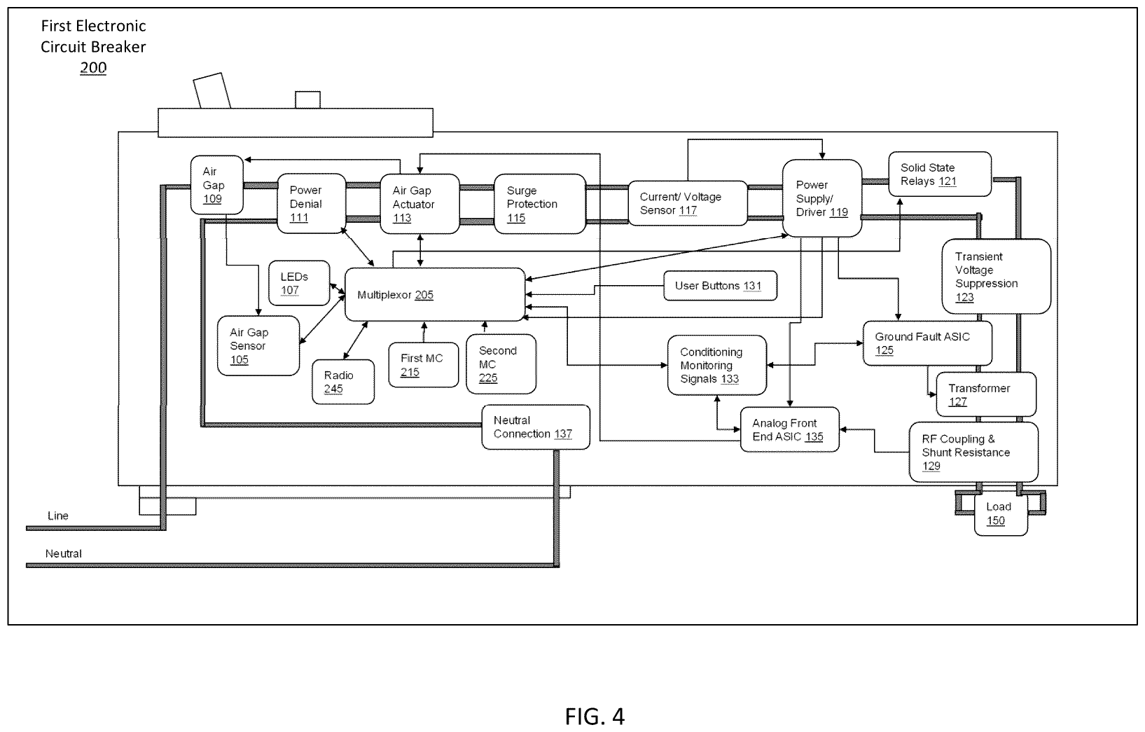

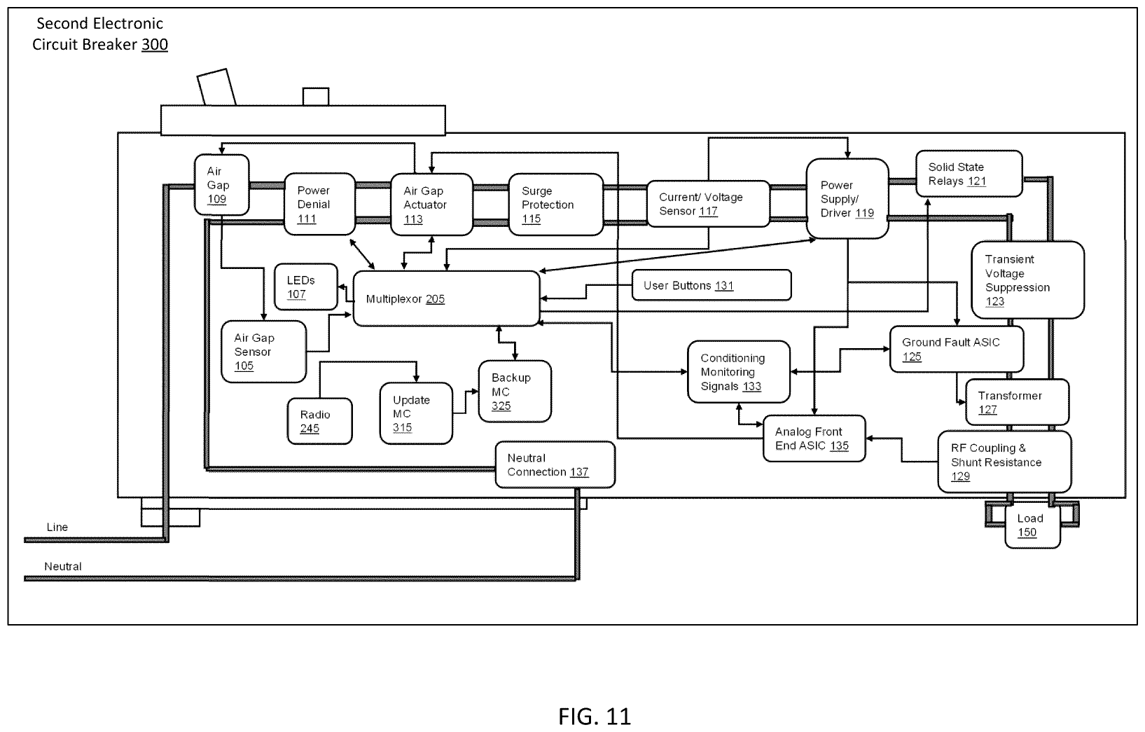

Embodiments described herein provide systems and methods for maintaining the functionality of an electronic circuit breaker (e.g., first electronic circuit breaker 200 of FIG. 4 and second electronic circuit breaker 300 of FIG. 11) during a firmware update. In a first embodiment, two microcontrollers (e.g., first microcontroller 215 and second microcontroller 225) are operated in parallel. When the first microcontroller 215 of the two microcontrollers is updated, the second microcontroller 225 of the two microcontrollers continues to provide monitoring and safety measures for the first electronic circuit breaker 200. After the first microcontroller 215 has been rebooted and is again actively monitoring the load, the second microcontroller 215 may then be similarly updated. In a second embodiment, two microcontrollers (updateable microcontroller 315 and backup microcontroller 325) are used. The updatable microcontroller 315 is updatable while the backup microcontroller 325 serves as a backup when the updatable microcontroller 315 is unavailable to provide the monitoring and safety measures for the circuit breaker 300. In either scenario, the electronic circuit breaker continuously monitors the load without any disruptions during a firmware update.

The primary function of a circuit breaker is to stop or limit the flow of current during an overload event or fault event. Although conventional electromechanical circuit breakers have a proven record as effective and reliable devices for circuit protection, emerging power distribution technologies and architectures, such as de microgrids, require improved interruption performance characteristics (e.g., faster switching speed). Newer electronic circuit breakers such as SOLID-STATE circuit breakers (SSCBs) are power semiconductor-based protection apparatuses, with no moving parts for fault current interruption. SSCBs provide excellent operational and system level benefits, including a shorter response time of semiconductor than that of the electromechanical mechanisms typical of conventional circuit breakers. In addition, electronic circuit breakers such as SSCBs may be programmable to alter the breaker algorithm to provide better performance or functionality. For example, by using a programmable algorithm, electronic circuit breakers may monitor different aspects of a load (e.g., voltage, power, frequency, etc.) and can react to specific scenarios. In addition, electronic circuit breakers may use code updates to fix issues or provide additional functionality instead of having to physically replace the circuit breaker. By being updatable, the lifespan of the circuit breakers may be extended to cover newer and different loads. In an example, if a new load is causing issues, engineers may look at the waveforms of the problematic load (e.g., captured and stored by the electronic circuit breaker) and recommend fixes in the breaker algorithm. A new firmware code that fixes the issue or provides additional functionality or monitoring may be prepared. This update may then be pushed out to all connected electronic circuit breakers. Breaker thresholds may also be altered or personalized to provide additional functionality. Updatable electronic circuit breakers save on costs by extending the life and functionality of circuit breakers and save on additional costs that may be involved in making expensive field visits from electricians or technicians.

These types of updatable electronic circuit breakers typically include firmware updates that result in disengaging the load. For example, a user may safely access the troubleshooting/updating modes only when the concerned product is identified as entered into “tripped state,” thereby de-energizing the load. A warning identifying that the load must be deenergized may be provided to the customer prior to the firmware update process, as the safety or protection function may be interrupted during the update process. The user/customer notified has to take necessary precautions or perform further actions in their ecosystem.

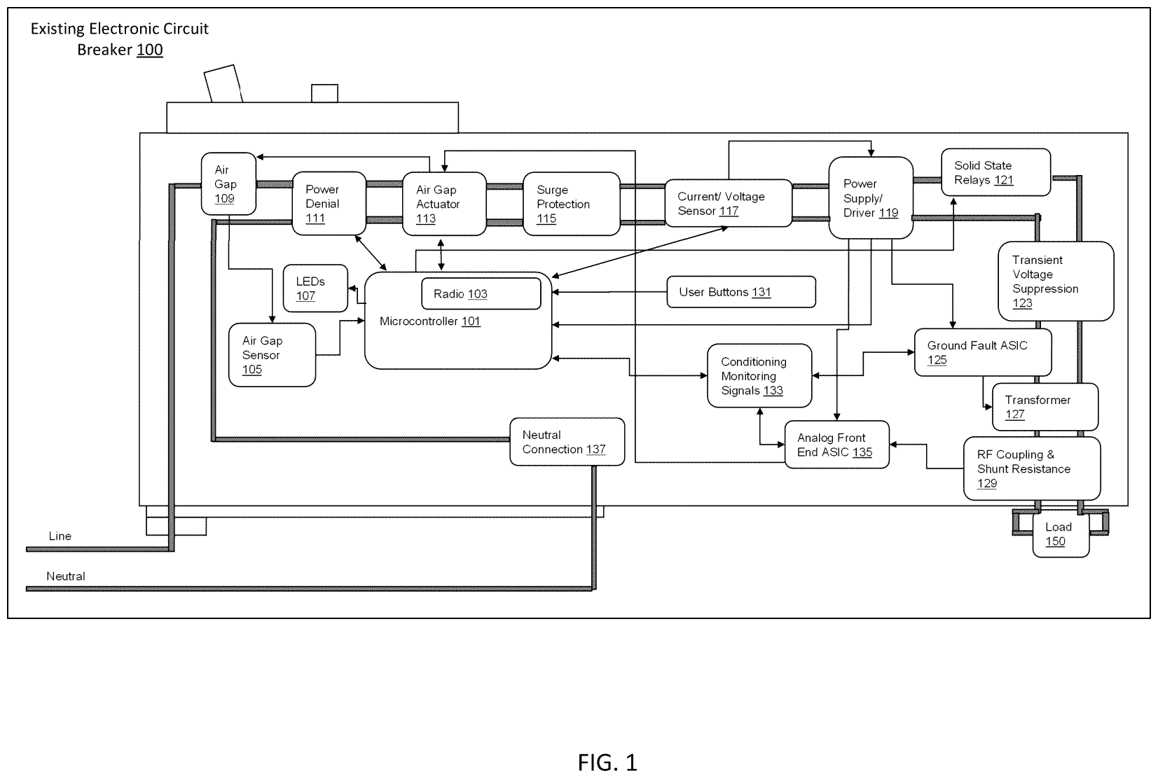

FIG. 1 depicts an example existing electronic circuit breaker 100. This type of circuit breaker 100 may be used in various setting such as homes, factories, dormitories, farmland, municipal engineering, intelligent remote control of water pumps, water heaters, floor heating equipment, etc. In FIG. 1, the electronic circuit breaker 100 (e.g., solid state circuit breaker) includes a microcontroller 101 with a radio 103 that provides a wireless link to an external remote device (not depicted). The microcontroller 101 is configured to monitor a load and provide a safety algorithm that prevents damage and/or injury as a result of an event. Loads may draw too much current, draw too much power, draw too much voltage, and/or create excessive heat, among other issues due to electrical faults. Under certain operating conditions, over currents may occur even in circuits without electrical faults. Overload currents can be caused by blocked drives or high starting currents, for example. Such an overload can cause damage to conductors and equipment if the overload continues for a prolonged period of time without being disconnected. Short-circuits in electrical systems may occur abruptly, for example, due to incorrect switching operations, assembly/commissioning errors, or faulty installations. These short-circuits carry a large amount of energy, which is released suddenly. The resulting damage to conductors and equipment can endanger people and/or machinery. The electronic circuit breaker 100 (e.g., solid state circuit breaker) of FIG. 1 is configured to prevent these issues by monitoring electrical systems and deenergizing or limiting loads when certain events occur that could cause issues.

Additional components that provide certain functions for the electronic circuit breaker are depicted. For example, the electronic circuit breaker 100 includes an air gap 109, an air gap actuator 113, a surge protection 115, a current/voltage sensor 117, a power supply/driver 119, an RF coupling and shunt resistance 129, etc. User buttons 131 and LEDs 107 may provide an interface for an operator. These components may provide inputs and outputs for the microcontroller 101. In operation, the microcontroller 101 monitors the load using these inputs and firmware code (e.g., a safety algorithm). When particular inputs (e.g., an event) are received that, for example, exceed thresholds, the microcontroller 101 outputs signals that lead to an action by the electronic circuit breaker 100, such as, for example, deenergizing the load. Different components may be included in different electronic circuit breakers 100. The depicted electronic circuit breaker 100 is only an example.

The microcontroller 101 monitors and runs a safety algorithm using firmware such as software or hardware code stored or implemented by the microcontroller 101. The firmware may be updated through a wired or an over the air (OTA) process. The radio 103 receives a firmware image/update from a remote source/device. The firmware image/update may include or be referred to as individual packets within the payload of the wireless data communication between the remote device and the radio 103. The radio 103 transfers these packets one by one to a buffer location within an internal flash memory of the microcontroller 101. The radio 103 receives a start packet and information of a number of packets the radio 103 should expect from the remote entity. At the end of the transfer of the firmware image, the radio 103 may receive a stop or end of transfer data packet from the remote entity. Once the image of the firmware has been successfully downloaded in its entirety or received by the radio 103 to internal flash of the microcontroller 101, for example, the microcontroller 101 performs a validation of a signature of the firmware image. This may be performed to calculate a cyclic redundancy check (CRC) of the entire downloaded firmware image. In other cases, prior to performing the CRC, a decryption method may be used to remove any encryption on the firmware image. If the signature verification or validation is complete, an internal software routine present in the flash memory of the microcontroller 101 known as bootloader will replace the existing algorithm with the received firmware image and reboot the microcontroller 101 with the new image.

One of the drawbacks of this process is that the internal flash memory running the current algorithm undergoes an erase and write function requiring a reboot/reset. During the update process and subsequent reboot/reset, the flash memory is considered in a busy state, and the electronic circuit breaker 100 has to pause its safety functions and monitoring from being active. Prior to de-energizing the load, a customer may be provided with a message detailing that the update process will start, the load will need to be de-energized during this process, and the customer should take necessary precautions as needed. This may include turning off devices or otherwise being prepared to deal with the inconvenience that the respective branch will be de-energized. After the update process is complete, the microcontroller reboots/resets, re-energizes the load, and starts monitoring again. While the load may be de-energized for a short period of time, any sort of interruption may be an inconvenience to the customer.

Embodiments provide systems and methods for maintaining the functionality of an electronic circuit breaker 200, 300 during a firmware update. In a first embodiment, two microcontrollers 215, 225 are run in parallel so that when a first microcontroller 215 is taken offline to be updated, the second microcontroller 225 is available to monitor and provide a safety algorithm for the first electronic circuit breaker 200. In another embodiment, an updatable microcontroller 315 is updatable while a backup microcontroller 325 serves as a backup for the second electronic circuit breaker 300. The embodiments described herein provide for continuous uptime of the monitoring and safety algorithm in an electronic circuit breaker 200, 300. This prevents a de-energization of the load when updating the electronic circuit breaker 200, 300. This allows the loads (e.g., electrical machines) to safely run all the time. This further allows for additional updates to be pushed out to electrical circuit breakers 200, 300, as downtime does not need to be scheduled. In addition, the use of multiple microcontrollers 215, 225, 315, 325 provides a further safety measure if one of the microcontrollers 215, 225, 315, 325 is unable to monitor or provide the safety algorithm during normal operations. The embodiments provide cost savings, more efficient operation, and more functionality for electronic circuit breakers.

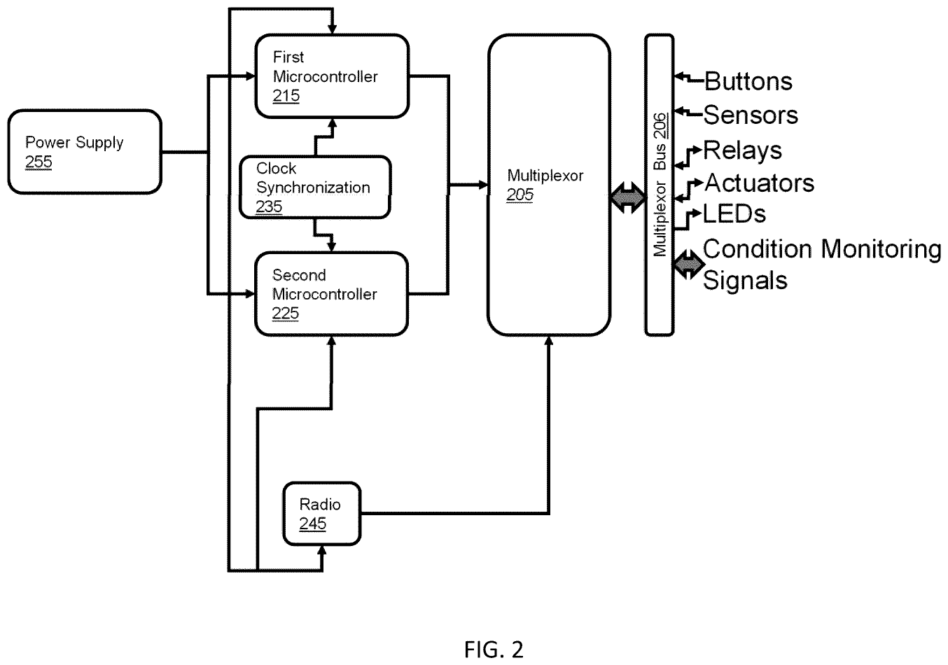

FIG. 2 depicts an embodiment of a system that provides for a firmware update without causing de-energization of the load. The system includes at least a power supply 255, a first microcontroller 215, a second microcontroller 225, a clock synchronization circuit 235, a multiplexor 205, a multiplexor bus 206, and a radio 245. The embodiments are described in relation to a first electronic circuit breaker 200, for example, as depicted in FIG. 4 described below. Embodiments, however, may be applied to any type of electronic circuit breaker that uses a microcontroller for monitoring the electronic circuit breaker. Any firmware update of such an electronic circuit breaker may benefit from the described embodiments. The embodiments are described using a single load. Multiple poles, branches, or loads protected by a circuit breaker may be implemented using the described systems and methods. Embodiments are described using two microcontrollers 215, 225. Additional microcontrollers may be used or implemented in certain electronic circuit breakers. If, for example, there are three or more microcontrollers, each microcontroller may be updated in sequence as described below while still maintaining the monitoring and safety measures.

In an embodiment, the first microcontroller 215 and the second microcontroller 225 are configured to be similar if not identical. The first microcontroller 215 and the second microcontroller 225 are configured to monitor the state of the first electronic circuit breaker 200 including the load. Both the first microcontroller 215 and the second microcontroller 225 are configured to run and respond according to a same programmable algorithm. The microcontrollers 215, 225 store the programmable algorithm in an internal memory (not depicted). As used herein, the instructions/computer code that a microcontroller 215, 225, 315, 325 is configured to run is referred to as firmware. Firmware, as used herein, is software that provides basic machine instructions that allow the hardware of the electronic circuit breaker 100, 200, 300 to function. Updating the firmware may require a reset or reboot of the microcontroller. The microcontrollers 215, 225 may include additional software that adds additional functionality on top of the firmware; however, the microcontrollers 215, 225 are unable to operate without instructions provided by the firmware. The firmware may be modified if the first electronic circuit breaker 200 does not function properly with a load (i.e., nuisance tripping) or if a new function is desired (e.g., to be added or enhanced, such as power metering, advanced tripping functions such as undervoltage).

The first microcontroller 215 and the second microcontroller 225 may include or be a general processor, digital signal processor, graphics processing unit, application specific integrated circuit, field programmable gate array, artificial intelligence processor, digital circuit, analog circuit, combinations thereof, or other now known or later developed processing/controller device. The first microcontroller 215 and the second microcontroller 225 may include a memory. The memory may be a volatile memory or a non-volatile memory. The memory may include one or more of a read-only memory (ROM), random access memory (RAM), a flash memory, an electronic erasable program read only memory (EEPROM), or other type of memory. The instructions for implementing the processes, methods, and/or techniques discussed herein may be provided on non-transitory computer-readable storage media or memories where applicable, such as a cache, buffer, RAM, removable media, hard drive, or other computer readable storage media (e.g., the memory). The instructions are executable by the microcontrollers, the radio 245, the multiplexor 205, or another component. The functions, acts, or tasks illustrated in the figures or described herein are executed in response to one or more sets of instructions stored in or on computer readable storage media. The functions, acts or tasks are independent of the instructions set, storage media, microcontroller, or processing strategy and may be performed by software, hardware, integrated circuits, firmware, micro code, and the like, operating alone or in combination. Because some of the constituent system components and method steps depicted in the accompanying figures may be implemented in software, the actual connections between the system components (or the process steps) may differ depending upon the manner in which the present embodiments are programmed.

The first microcontroller 215 and the second microcontroller 225 are configured to receive signal data from the multiplexor 205 and determine whether or not an action should be performed based on the safety algorithm. The first microcontroller 215 and the second microcontroller 225 may also be configured to store the signal data for later analysis. For example, the first microcontroller 215 and the second microcontroller 225 may store data relating to the voltage, power, waveform, frequency, etc. of the load.

The multiplexor 205 (also referred to as a multiplexer 205) is configured to handle inputs and outputs for the first microcontroller 215 and the second microcontroller 225. The multiplexor 205 may be connected to one or more of the components of the first electronic circuit breaker 200, such as the buttons, sensors, relays, actuators, and LEDs. The multiplexor 205 may be provided with a multiplexor bus 206 on which the signals from the various components are transmitted to the multiplexor 205. The multiplexor 205 may be configured to disengage or engage the first microcontroller 215 and the second microcontroller 225, thereby allowing or preventing signals from the various components to be transmitted to the first microcontroller 215 and the second microcontroller 225. In operation, the multiplexor 205 provides signals to one or both of the first microcontroller 215 and the second microcontroller 225, depending on whether or not an update is in process. During update of one of the first microcontroller 215 and the second microcontroller 225, the multiplexor 205 may cease inputs and outputs to the updating one microcontroller 215 or 225 while continuing to transmit signals to the other non-updating microcontroller 225 or 215. The multiplexor 205 may be configured to combine signals from the first microcontroller 215 and the second microcontroller 225 using an OR function. For example, if the first microcontroller 215 sends a signal to perform an action, and the second microcontroller 225 does not, the multiplexor 205 will perform the action. In this way, an instruction from either microcontroller of the first microcontroller 215 and the second microcontroller 225 to provide a safety measure will be implemented. In the case of conflicting instructions, the multiplexor 205 may default to the safest option. In practice, conflicting signals should not exist as the first microcontroller 215 and the second microcontroller 225 are performing the same algorithm based on the same inputs. To maintain identical outputs in response to the same inputs, the first microcontroller 215 and the second microcontroller 225 may be clock synchronized using a clock synchronization circuit 235.

The clock synchronization circuit 235 is configured to coordinate the independent clocks of the microcontrollers 215, 225. If the independent clocks are not properly synchronized, failure of the monitoring and/or safety algorithm may occur. Any clock synchronization circuit 235 that synchronizes the clocks and therefore the operation of the microcontrollers 215, 225 may be used. The clock synchronization circuit 235 may be implemented using hardware or software.

The radio 245 is configured to receive the firmware update from a remote source. The radio 245 may be configured to perform a CRC or other check on the received packets, image, or update data. The radio 245 is further configured to transmit the firmware update or individual packets to the first microcontroller 215 and the second microcontroller 225. The radio 245 may further communicate with the multiplexor 205 to send a signal to disengage the inputs and outputs of a microcontroller of the first microcontroller 215 and the second microcontroller 225 in preparation for the update process described herein. The radio 245 may be configured for radio frequency communication (e.g., generate, transit, and receive radio signals) of any of the wireless networks described herein.

The radio 245 may communicate over networks including wired networks, wireless networks, or combinations thereof. The wireless network may be a cellular telephone network, LTE (Long-Term Evolution), 4G LTE, a wireless local area network, such as an 802.11, 802.16, 802.20, WiMAX (Worldwide Interoperability for Microwave Access) network, DSRC (otherwise known as WAVE, ITS-G5, or 802.11p and future generations thereof), a 5G wireless network, or wireless short-range network such as Zigbee, Bluetooth Low Energy, Z-Wave, RFID and NFC. Further, the network may be a public network, such as the Internet, a private network, such as an intranet, or combinations thereof, and may utilize a variety of networking protocols now available or later developed including, but not limited to, transmission control protocol/internet protocol (TCP/IP) based networking protocols.

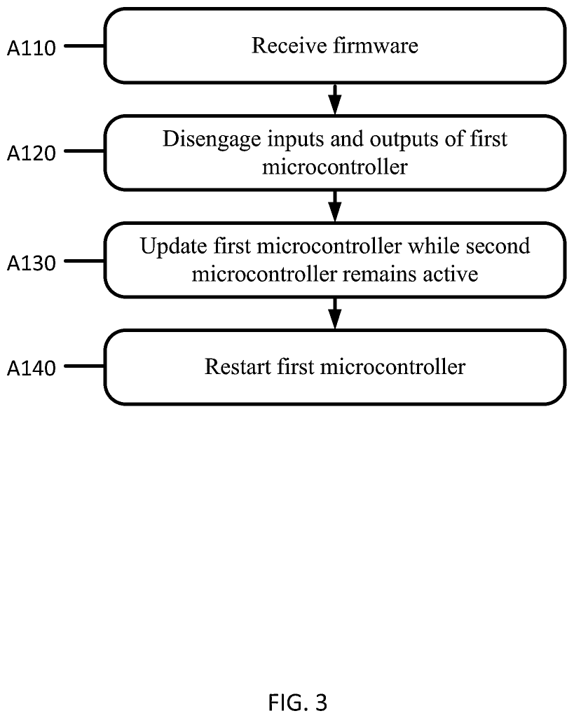

FIG. 3 depicts an example of a method for maintaining the functionality of a first electronic circuit breaker (e.g., the circuit breaker 200) during a firmware update using, for example, the system of FIG. 2. Two or more microcontrollers (e.g., the microcontrollers 215, 225) may be wirelessly updated through an OTA process. Both the microcontrollers 215, 225 have access to the inputs and provide outputs to same sources and destinations through a multiplexor (e.g., the multiplexor 205). The microcontrollers 215, 225 continue to run a same algorithm prior to the OTA process. The method is performed by the system of FIG. 2, FIG. 4, or another system. The method is performed in the order shown or other orders. Additional, different, or fewer acts may be provided. The microcontrollers 215, 225 are provided power by a same power supply. The algorithm and the instructions running on the microcontrollers 215, 225 require an internal or external clock for performing the operations. The two microcontrollers 215, 225 running the same algorithms and instructions may need the clock between the two microcontrollers 215, 225 to be synchronized periodically to provide that the instructions are occurring at the same frequency. A clock synchronization circuit 235 may be used to synchronize the clocks of the two microcontrollers 215, 225 or otherwise provide for the two microcontrollers 215, 225 to provide the same signals to the multiplexor 205 when input the same signals.

At act A110, a radio (e.g., the radio 245) receives a firmware image in sections of a total memory, referred to as individual packets, within a payload of a wireless data communication between a remote device and the radio 245. The radio 245 transfers these “packets “one by one to a buffer location within an internal flash memory of the first microcontroller 215. The radio 245 receives a start packet and information of a number of packets the radio 245 should expect from the remote entity. At the end of the transfer of the firmware image, the radio 245 may receive a stop or end of transfer data packet from the remote entity. All through the update process, the first microcontroller 215 and the second microcontroller 225 continue to run the same algorithm.

At act A120, once the image of the firmware has been successfully completely received by the radio 245 or downloaded to the internal flash of the first microcontroller 215, the radio 245 sends a signal to the multiplexor 205 component to disengage the inputs and outputs of the first microcontroller 215. During this process, the second microcontroller 225 continues to provide monitoring of the first electronic circuit breaker 200, and the safety algorithm continues to run.

At act A130, once the inputs and outputs of the first microcontroller 215 have been disengaged, the radio 245 sends a message to the first microcontroller 215 to continue to perform the remaining tasks in the update process. The first microcontroller 215 proceeds to perform a validation of the signature of the firmware image. This can be performed to calculate the CRC of the entire downloaded firmware image. In other cases, prior to performing the CRC, a decryption method may be used to remove any encryption on the firmware image. If the signature verification or validation is complete, an internal software routine present in the flash memory of the first microcontroller 215 known as a bootloader will replace the existing algorithm with the received firmware image and reboot the first microcontroller 215 with the new image. Even though it is understood that the first microcontroller 215 will undergo a reset after successful update process, the first electronic circuit breaker 200 will not have to pause its safety functions and features from being active, as the algorithms and instructions continue to be operable through the second microcontroller 225.

At act A140, once the first microcontroller 215 has been successfully updated and rebooted/reset, the first microcontroller 215 starts performing the monitoring of the inputs and provides necessary safety features by actuating or activating the necessary outputs. Subsequently, the radio 245 may proceed to coordinate the update of the second microcontroller 225 using similar actions as those of A120-A140. Alternatively, the second microcontroller 225 may be updated first, while the first microcontroller 215 maintains the necessary safety functionality.

In this method, the customer may be notified that the firmware is being updated (e.g., with a message detailing any changes), but there is no loss of power or protection functionality, and the customer does not have to take any additional precautions.

FIG. 4 depicts an example of a first electronic circuit breaker 200 with a plurality of components. FIG. 4 is similar to FIG. 1 described above. However, FIG. 4 includes the components of FIG. 2, including the microcontrollers 215, 225 and the multiplexor 205. The first electronic circuit breaker 200 of FIG. 4 provides for a firmware update process wirelessly. The first electronic circuit breaker 200 includes a minimum of two microcontrollers 215, 225 that are clock synchronized with each other, running the same algorithm. Inputs and outputs of the microcontrollers' 215, 225 are controlled by a multiplexor 205 unit that is controllable through an external input. The first electronic circuit breaker 200 further includes a radio 245 configured for receiving the new firmware image from a remote device (not depicted) and storing the new firmware image in the first microcontroller 215 and the second microcontroller 225. The radio 245, upon receipt of a start packet and a number of packets, receives individual packets from the remote device. The radio 245 receives a stop or end packet to signify the completion of the receipt of the firmware image. The radio 245 instructs the multiplexor 205 unit to disengage the inputs and outputs of the first microcontroller 215. The radio 245 instructs the first microcontroller 215 to continue the update process, which may include decrypting the received firmware image, verifying the signature of the new firmware image, and invoking the bootloader to load the new image into flash memory of the first microcontroller 215 for running the update. The second microcontroller 225 continues to run the safety algorithm while the first microcontroller 215 undergoes the update process and is ready to run the application again. The second microcontroller 225 may update later after the identified microcontroller is able to provide the safety functionality.

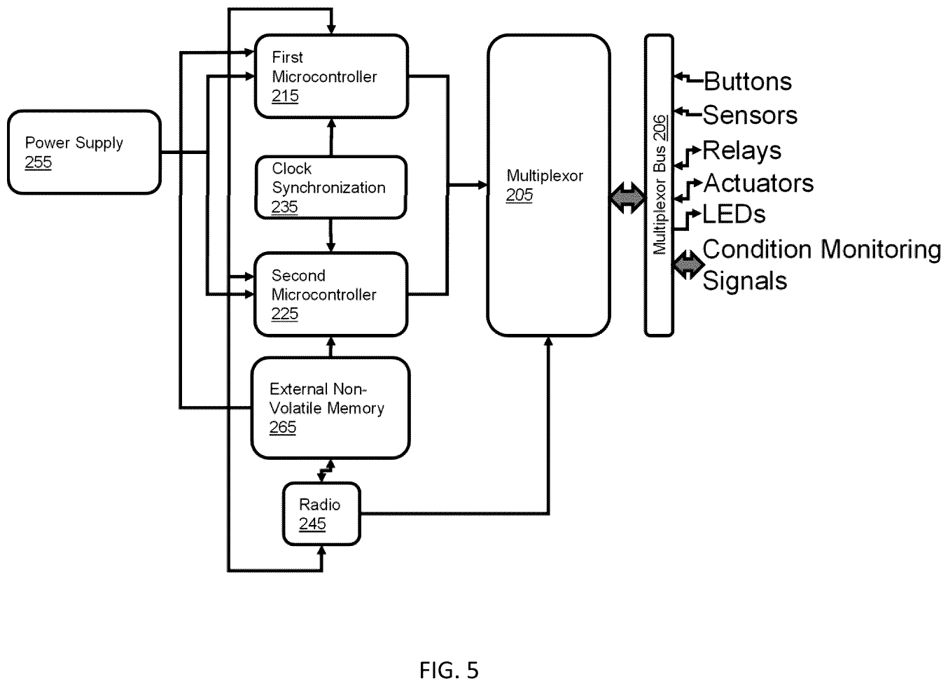

In an embodiment, the two or more microcontrollers 215, 225 may be wirelessly updated through an over the air (OTA) process using an external nonvolatile memory 265. This is described in block diagrams shown in FIG. 5. A location of the nonvolatile memory 265 is not tied to a specific microcontroller 215, 225. In an embodiment in which more than two microcontrollers 215, 225 are included, this architecture provides additional modularity in sharing the information between multiple microcontrollers 215, 225 without burdening the individual flash memory of each of the microcontrollers 215, 225.

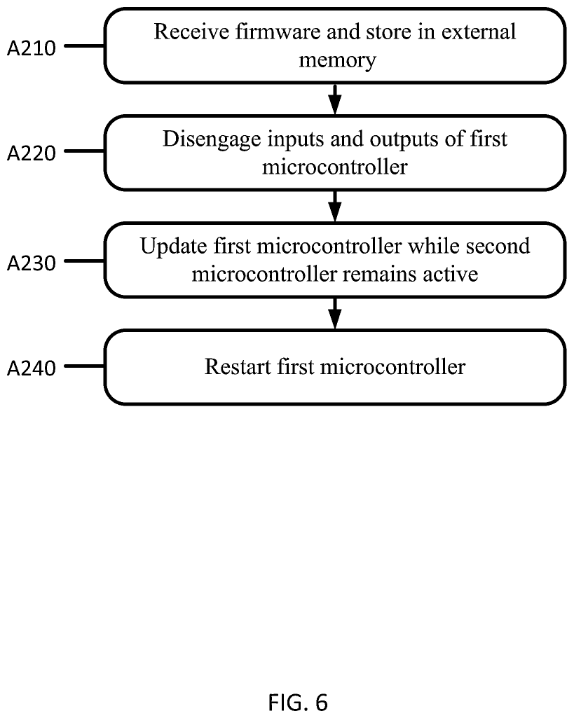

FIG. 6 depicts an example of a method for updating an electronic circuit breaker using the system of FIG. 5. The two or more microcontrollers 215, 225 are wirelessly updated. Both the microcontrollers 215, 225 have access to the inputs and provide outputs to the same sources and destinations through the multiplexor 205. The microcontrollers 215, 225 continue to run the same algorithm prior to the OTA process. The method is performed by the system of FIG. 4, FIG. 5, or another system. The method is performed in the order shown or other orders. Additional, different, or fewer acts may be provided.

At act A210, a radio (e.g., the radio 245) receives a firmware image as packets within a payload of a wireless data communication between a remote device and the radio 245. The radio 245 transfers the packets one by one to a buffer location within an external nonvolatile flash memory (e.g., the external nonvolatile flash memory 265). The radio 245 receives a start packet and information describing a number of packets the radio 245 should expect to receive from the remote entity. At the end of the transfer of the firmware image, the radio 245 may receive a stop or end of transfer data packet from the remote entity. All through the update process, the two or more microcontrollers 215, 225 continue to run the same algorithm.

At act A220, once the image of the firmware has been successfully completely received by the radio 245 or downloaded in the external nonvolatile flash memory 265, the radio 245 sends a signal to the multiplexor 205 to randomly pick one of the two or more microcontrollers 215, 225 to be the first microcontroller 215 to undergo an update process. In another embodiment, the multiplexor 205 can decide to pick the first microcontroller 215 to undergo the update process and continue with the next or remaining microcontroller 225 when the next or remaining microcontroller 225 is ready to be updated. The multiplexor 205 disengages the inputs and outputs of the first microcontroller 215. During this process, the second microcontroller 225 continues to provide the safety algorithm running at all times.

At act A230, once the inputs and outputs of the first microcontroller 215 have been disengaged, the radio 245 sends a message to the first microcontroller 215 to continue to perform the remaining tasks in the update process. The first microcontroller 215 proceeds to perform a validation of the signature of the firmware image of the firmware now present in the external nonvolatile memory 265. This can be performed to calculate the cyclic redundancy check of the entire downloaded firmware image. In other cases, prior to performing the CRC, a decryption method may be used to remove any encryption on the firmware image. Once the signature verification or validation is complete, an internal software routine present in the flash memory of the first microcontroller 215 known as bootloader replaces the existing algorithm with the firmware image located at the external nonvolatile memory 265 and reboots the first microcontroller 215 with the new firmware image. Even though the first microcontroller 215 will undergo a reset after a successful update process, the electronic circuit breaker will not have to pause its safety functions and features from being active, as the algorithms and instructions continue to be operable through the second microcontroller 225.

At act A240, once the first microcontroller 215 has successfully updated, the first microcontroller 215 can start performing the monitoring of the inputs and provide necessary safety features by actuating or activating the necessary outputs. Subsequently the radio 245 may proceed to coordinate the update of the second microcontroller 225 using similar steps (acts A220-230). In another embodiment of this method, the second microcontroller 225 may be updated first, while the first microcontroller 215 maintains the necessary safety functionality.

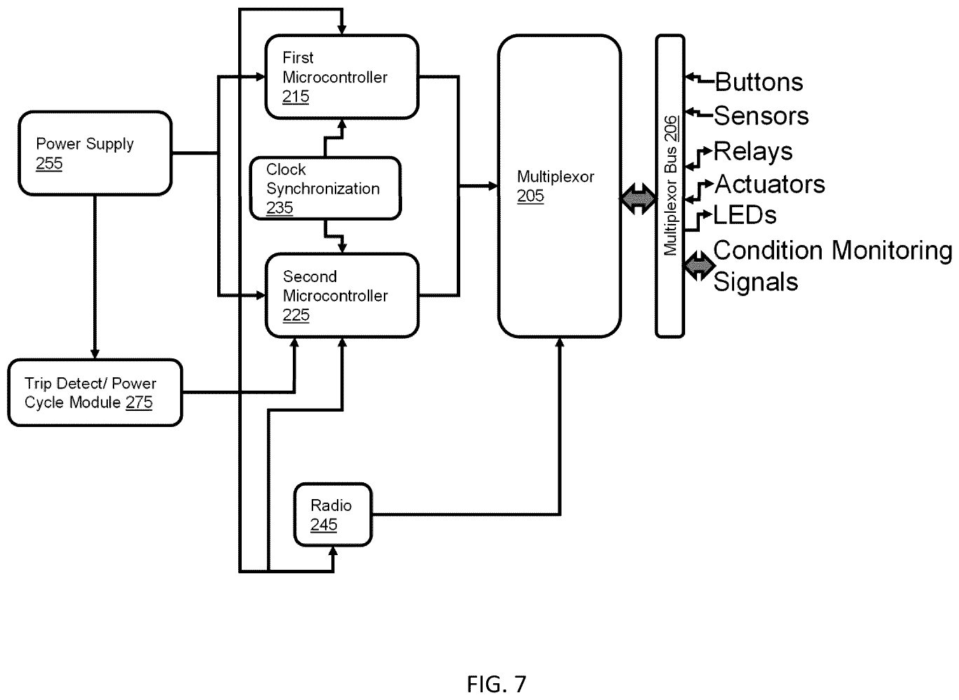

In another embodiment, the two or more microcontrollers 215, 225 may be wirelessly updated through an over the air (OTA) process using an external nonvolatile memory 265 only after a trigger condition has been met or acknowledged. The trigger for the firmware update process may be provided by a trip detection/power cycle unit 275 that monitors the trip detection or power cycle event. The trip detection/power cycle unit 275 may connect to a host selection interrupt line that may provide an acknowledgment instructing the backup microcontroller to being the safety monitoring. This is described in block diagrams shown in FIG. 7. The trip detection/power cycle unit 275 monitoring the trip detection may be hardware monitoring the trip circuit within the electronic circuit breaker. In other embodiments, the trip detection/power cycle unit 275 monitoring the power cycle may be hardware monitoring the power cycle/driver within the electronic circuit breaker. This embodiment provides that the OTA process is triggered at the start of a power cycle or restoration of the breaker from a tripped condition. This results in the OTA process being performed or conducted during a controlled and timed environment for the purpose of providing any specific information to the customer.

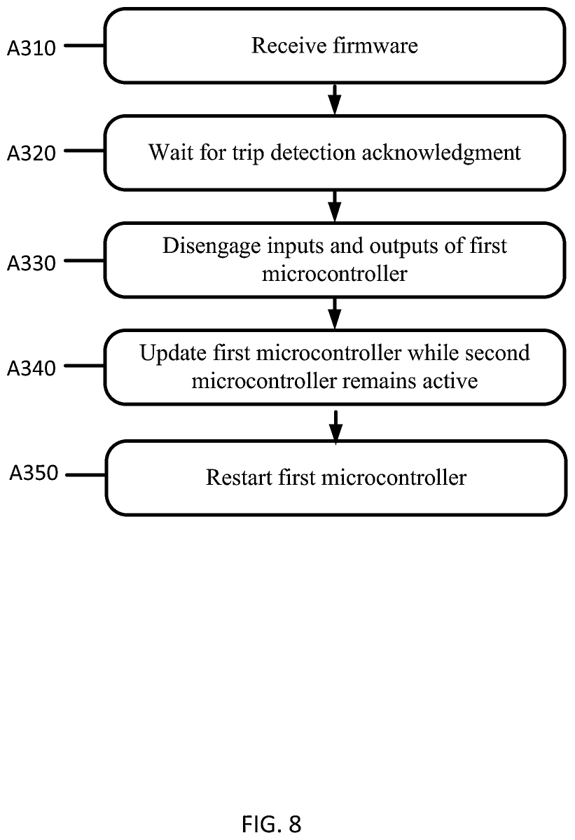

FIG. 8 depicts an example of a method for wirelessly updating two or more microcontrollers 215, 225 in a first electronic circuit breaker 200 using the system of FIG. 7. The first microcontroller 215 and the second microcontroller 225 may be wirelessly updated through an over the air (OTA) process. Both the first microcontroller 215 and the second microcontroller 225 have access to the inputs and provide outputs to the same sources and destinations through the multiplexor 205. The first microcontroller 215 and the second microcontroller 225 continue to run the same algorithm prior to the OTA process. The method is performed by the system of FIG. 4, the system of FIG. 7, or another system. The method is performed in the order shown or other orders. Additional, different, or fewer acts may be provided.

At act A310, a radio (e.g., the radio 245) receives a firmware image as packets within a payload of a wireless data communication between a remote device and the radio 245. The radio 245 transfers the packets one by one to a buffer location within an external nonvolatile flash memory 265 (not shown in figure) or internal memories of a first microcontroller and a second microcontroller (e.g., the first microcontroller 215 and the second microcontroller 225). The location of the nonvolatile flash memory 265 is not tied to a specific microcontroller 215, 225. In an embodiment in which more than two microcontrollers 215, 225 are included, this architecture provides additional modularity in sharing the information between multiple microcontrollers 215, 225. The radio 245 receives a start packet and information of the number of packets the radio 245 should expect from the remote entity. At the end of the transfer of the firmware image, the radio 245 may receive a stop or end of transfer data packet from the remote entity. During this step, the microcontrollers 215, 225 continue to run the safety algorithm.

At act A320, once the image of the firmware has been successfully completely downloaded to an external nonvolatile flash memory (e.g., the external nonvolatile flash memory 265) or received by the radio 245, the radio 245 checks if a module performing the trip detection (e.g., the module 275) has identified an acknowledgement. This acknowledgement can be stored in an identified location or a specific location in the external nonvolatile memory 265. The radio 245 may periodically poll this location to check if an acknowledgement is made. In order to provide the acknowledgement, one or both of the microcontrollers 215, 225 running the safety algorithm have identified the presence of fault conditions and have made the decision to cause the electronic circuit breaker to enter a tripped condition. Once the electronic circuit breaker is restored from the tripped condition through remote or user interaction, the radio 245 polls the acknowledgement and overwrites with a read acknowledgement in the same identified location or specific location in the external nonvolatile memory 265. The radio 245 sends a signal to the multiplexor 205 to begin the update process.

In another embodiment, the same operation as described above may take place using a power cycle event instead of trip detection. The multiplexor 205 is now tasked by the radio 245 to pick one microcontroller of the first microcontroller 215 and the second microcontroller 225 to be the first microcontroller 215 to undergo an update process. In another embodiment, the multiplexor 205 may pick the first microcontroller 215 to undergo the update process and continue with the second microcontroller 225 when the second microcontroller 225 is ready to be updated. A host selection line may provide an acknowledgment for the backup microcontroller to be safety monitoring.

At act A330, the multiplexor 205 disengages the inputs and outputs of the first microcontroller 215. The second microcontroller 225 continues to provide the safety algorithm while the first microcontroller 215 is updated.

At act A340, once the inputs and outputs of the first microcontroller 215 have been disengaged, the radio 245 sends a message to the first microcontroller 215 to continue to perform the remaining tasks in the update process. The first microcontroller 215 proceeds to perform a validation of the signature of the firmware image of the firmware now present in the external nonvolatile memory 265. This can be performed to calculate the cyclic redundancy check of the entire downloaded firmware image. In other cases, prior to performing the CRC, a decryption method may be used to remove any encryption on the firmware image. If the signature verification or validation is complete, an internal software routine present in the flash memory of the first microcontroller 215 known as a bootloader replaces the existing algorithm with the firmware image located from the external nonvolatile memory 265 and reboots the first microcontroller 215 with the new image. While the first microcontroller 215 will undergo a reset after successful update process, the electronic circuit breaker will not have to pause its safety functions and features from being active, as the algorithms and instructions continue to be operable through the second microcontroller 225.

At act A350, once the first microcontroller 215 has successfully been updated, the first microcontroller 215 may restart the monitoring of the inputs in order to provide necessary safety features by actuating or activating the necessary outputs. Subsequently, the radio 245 may proceed to coordinate the update of the second microcontroller 225 using similar steps. In another embodiment of this method, the second microcontroller 225 may be updated first while the first microcontroller 215 maintains the necessary safety functionality.

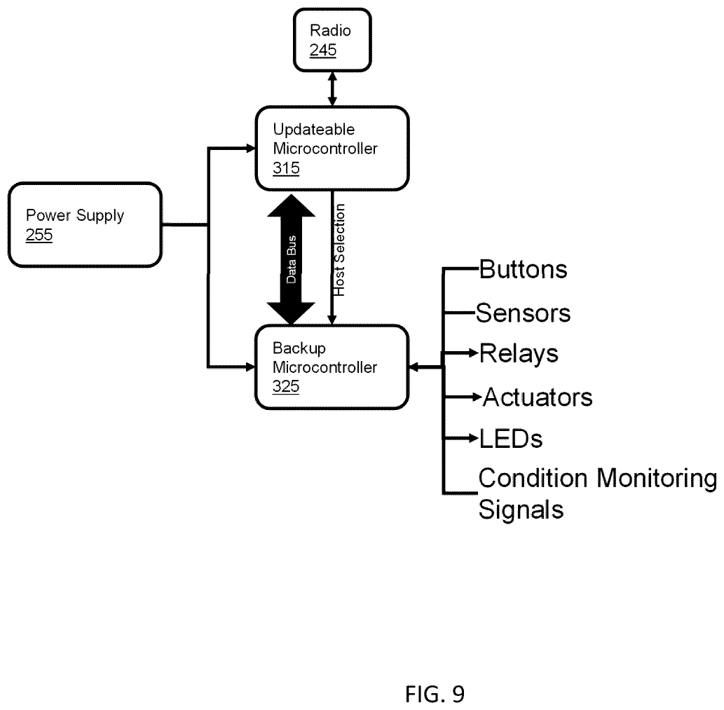

In FIG. 9, an alternative system is depicted in the form of a block diagram. There are two microcontrollers 315, 325, one designated at an updatable microcontroller 315 and one designated as a central or backup microcontroller 325. The microcontroller designated as an updatable microcontroller 315 is wirelessly updated through an over the air (OTA) process. The updatable microcontroller 315 has access to inputs and outputs connected to the backup microcontroller 325 through a hi-speed data bus that is used to transfer measured data and issue commands back to the backup microcontroller 325. The backup microcontroller 325 performs its default role unless instructed by updatable microcontroller 315 through a host selection interrupt line that it is available and ready to manage operations through the hi-speed data bus. The backup microcontroller 325 is used for safety monitoring in case of firmware upgrade procedures or failure with the updatable microcontroller 315, and is not considered to be updatable.

The radio 245 provides the wireless link to an external remote device. The radio 245 in this description may include a single or multiple primary processors with a flash memory containing some logic to perform control actions as described herein. The two microcontrollers 315, 325 have designated roles that work together during normal operations and the firmware update process. The inputs and outputs are passed through the backup microcontroller 325 to provide individual peripherals with the inputs and outputs necessary for their operation.

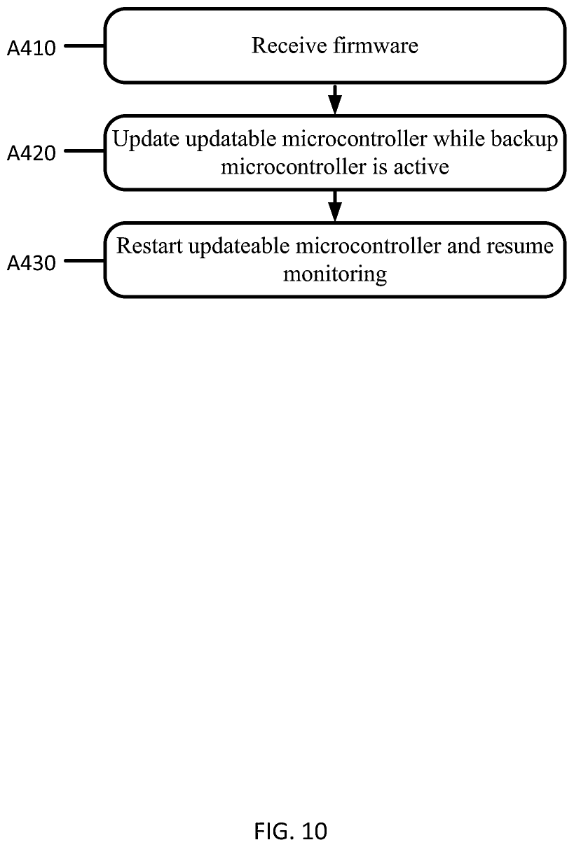

FIG. 10 depicts an example of a method for updating a second electronic circuit breaker 300 using, for example, the system of FIG. 9. An updatable microcontroller (e.g., the updatable microcontroller 315) may be wirelessly updated through an over the air (OTA) process. Both the updatable microcontroller 315 and a backup microcontroller (e.g., the backup microcontroller 325) have access to the inputs and provide outputs to the same sources and destinations (e.g., through the backup microcontroller 325). The microcontrollers 315, 325 continue to run the same algorithm prior to the OTA process. The method is performed by the system of FIG. 9 or another system. The method is performed in the order shown or other orders. Additional, different, or fewer acts may be provided.

At act A410, a radio (e.g., the radio 245) receives a firmware image as packets within a payload of a wireless data communication between the remote device and the radio 245. The radio 245 transfers the packets to a buffer location within an internal memory of the updatable microcontroller 315. The radio 245 receives a start packet and information of the number of packets the radio 245 should expect from the remote entity. At the end of the transfer of the firmware image, the radio 245 may receive a stop or end of transfer data packet from the remote entity.

At act A420, once the image of the firmware has been successfully completely downloaded to internal flash of the updatable microcontroller 315 or received by the radio 245, the updatable microcontroller 315 proceeds to perform a validation of a signature of the firmware image. This may be performed to calculate a cyclic redundancy check of the entire downloaded firmware image. In other cases, prior to performing the CRC, a decryption method may be used to remove any encryption on the firmware image. If the signature verification or validation is complete, an internal software routine present in the flash memory of the updatable microcontroller 315 known as bootloader will replace the existing algorithm with the received firmware image and reboot the updatable microcontroller 315 with the new image. During this time, the backup microcontroller 325 assumes the role for monitoring safety throughout the update process while the updatable microcontroller 315 is unavailable. Even though it is understood that the updatable microcontroller 315 will undergo a reset after a successful update process, the second electronic circuit breaker 300 will not have to pause its safety functions and features from being active, as the algorithms and instructions continue to be operable through the backup microcontroller 325.

At act A430, once the updatable microcontroller 315 has successfully updated, the updatable microcontroller 315 can instruct the backup microcontroller 325 the updatable microcontroller 315 is ready to resume monitoring of the inputs and provide necessary safety features by actuating or activating the necessary outputs through the hi-speed data bus through the backup microcontroller 325. The backup microcontroller 325 passes the input/output signals to the updatable microcontroller 315 and waits until the backup microcontroller 325 is needed again. The backup microcontroller 325 may run a simple algorithm that errors on the side of safety. The backup microcontroller 325 may never be updated, for example, as long as its algorithm is safe. The backup microcontroller 325 may not provide the same functionality as the updateable microcontroller 315 due to not receiving updates, but the backup microcontroller 325 is configured to provide basic safety measures for the short period of time that the updatable microcontroller 315 is unavailable, thus preventing downtime of any device connected as a load to the second electronic circuit breaker 300.

It is to be understood that the elements and features recited in the appended claims may be combined in different ways to produce new claims that likewise fall within the scope of the present invention. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description. Independent of the grammatical term usage, individuals with male, female or other gender identities are included within the term.

1. A method for updating an electronic circuit breaker with new firmware, the method comprising:
receiving, by a radio, a firmware update for the electronic circuit breaker;
disengaging, by a multiplexor, inputs to and outputs from a first microcontroller while maintaining inputs to and outputs from a second microcontroller, wherein the first microcontroller and second microcontroller are both configured to monitor the electronic circuit breaker and run a safety algorithm based on the respective inputs to and outputs from the multiplexor;
updating the first microcontroller with the firmware update, wherein the second microcontroller is configured to continue to monitor the electronic circuit breaker and run the safety algorithm while the first microcontroller is updated; and
restarting the first microcontroller, wherein after the restarting, the first microcontroller is configured to monitor the electronic circuit breaker and run the safety algorithm using the new firmware update.

2. The method of claim 1, further comprising:
disengaging, by the multiplexor, the inputs to and the outputs from the second microcontroller while maintaining the inputs to and the outputs from the first microcontroller;
updating the second microcontroller with the firmware update, wherein the first microcontroller is configured to continue to monitor the electronic circuit breaker and run the safety algorithm while the second microcontroller is updated; and
restarting the second microcontroller, wherein after the restarting of the second microcontroller, the second microcontroller is configured to monitor the electronic circuit breaker and run the safety algorithm using the new firmware update.

3. The method of claim 1, wherein receiving the firmware update comprises receiving, by the radio, individual packets comprising the firmware update from a remote device, and
wherein the method further comprises receiving, by the radio, a stop packet or an end packet that signifies a completion of a receipt of the firmware update.

4. The method of claim 1, further comprising instructing, by the radio, the multiplexor to disengage the inputs to and the outputs from the first microcontroller.

5. The method of claim 1, further comprising storing the firmware update in each of the first microcontroller and the second microcontroller after the receiving by the radio and prior to updating the first microcontroller.

6. The method of claim 1, further comprising storing the firmware update in a nonvolatile flash memory external to the first microcontroller and the second microcontroller.

7. The method of claim 1, further comprising:
receiving an acknowledgement from a trip detection or power cycle detection module prior to the multiplexor disengaging the inputs to and the outputs from the first microcontroller.

8. The method of claim 1, wherein the radio is configured to receive the firmware update wirelessly.

9. A method for updating an electronic circuit breaker with new firmware, the method comprising:
receiving, by a radio, a firmware update for the electronic circuit breaker;
instructing, by an updatable microcontroller, a backup microcontroller to begin safety monitoring during an update procedure for the updatable microcontroller;
updating the updatable microcontroller with the firmware update, wherein the backup microcontroller is configured to continue to monitor the electronic circuit breaker and run a safety algorithm while the updatable microcontroller is updating; and
restarting the updatable microcontroller, wherein after the restart the updatable microcontroller is configured to monitor the electronic circuit breaker and run the safety algorithm using the firmware update.

10. The method of claim 9, wherein the backup microcontroller functions as a pass though circuit for signals from the electronic circuit breaker while the updatable microcontroller is active, wherein when the updatable microcontroller is deactivated, the backup microcontroller performs the safety algorithm.

11. The method of claim 9, wherein the backup microcontroller is not updated.

12. The method of claim 9, further comprising:
receiving an acknowledgement from a host selection interrupt line prior to the updatable microcontroller instructing the backup microcontroller to begin the safety monitoring.

13. The method of claim 9, wherein receiving the firmware update comprises receiving, by the radio, individual packets comprising the firmware update from a remote device, and
wherein the method further comprises receiving, by the radio, a stop packet or an end packet that signifies a completion of a receipt of the firmware update.

14. An electronic circuit breaker comprising:
two or more microcontrollers configured to run an algorithm for monitoring and controlling a load of the electronic circuit breaker; and
a radio configured to receive new firmware data from a remote device, the new firmware data configured to alter the algorithm;
wherein a first microcontroller of the two or more microcontrollers is actively running the algorithm when a second microcontroller of the two or more microcontrollers is deactivated and updated with the new firmware data.

15. The electronic circuit breaker of claim 14, further comprising:
a multiplexor configured to provide inputs to and receive outputs from the two or more microcontrollers.

16. The electronic circuit breaker of claim 15, wherein after receiving the new firmware data, the radio instructs the multiplexor to disengage the inputs and outputs of the first microcontroller.

17. The electronic circuit breaker of claim 14, wherein subsequent to the second microcontroller being restarted or rebooted after being updated, the second microcontroller is configured to run the algorithm while the first microcontroller is deactivated and updated with the new firmware data.

18. The electronic circuit breaker of claim 14, wherein the first microcontroller is not updatable, wherein the first microcontroller functions as a backup during a deactivation of the second microcontroller.

19. The electronic circuit breaker of claim 18, the first microcontroller functions as a pass though circuit for signals from the electronic circuit breaker while the second microcontroller is active, wherein when the second microcontroller is deactivated, the first microcontroller performs the algorithm.

20. The electronic circuit breaker of claim 14, further comprising:
a nonvolatile flash memory external to the two or more microcontrollers, the nonvolatile flash memory configured to store the received new firmware data.
